(19) United States
(12) Patent Application Publication
(10) Pub. No.: US 2005/0146458 A1
(43) Pub. Date: Jul. 7, 2005

(54) Vehicular electronics interface module and related methods

(76) Inventors: Steve Douglas Carmichael, Raymond, NH (US); Kimble Jon Smith, Loveland, CO (US); Todd J. Cottle, Mt. Zion, IL (US)

Correspondence Address: Cook, Alex, McFarron, Manzo, Cummings & Mehler, Suite 2850, 200 West Adams, Chicago, IL, 60606, US

(21) Appl. No.: 10/753,148

(22) Filed: Jan. 7, 2004

(51) Int. Cl. G01S 13/86

(52) U.S. Cl. 342/52; 342/55; 342/70; 342/175

(57) ABSTRACT

An interface module for interfacing on-board electronics in a vehicle with a radar device and/or camera. A plurality of data busses are configured for different signaling protocols, such as variable pulse width, pulse width modulated and ISO 9141. A data processor activates the data busses and selects the bus that is most compatible with the on-board electronics. Data is then received and translated to a form compatible with the radar device and/or camera. Typically, the data provided will be vehicle speed information which is used by the radar device to identify the best candidate in the radar Doppler return or is displayed with images taken by the camera. The speed information is also used to control the field of view of the camera, with wider angles of view used for lower speeds. Related methods are also disclosed.

### FIELD OF THE INVENTION

This invention generally relates to traffic radar. More particularly, this invention relates to a apparatus for interfacing on-board vehicular electronics with traffic radar and/or video surveillance systems.

### BACKGROUND OF THE INVENTION

Traffic radar devices are in widespread use to determine the speed of a target vehicle. Such radar devices transmit radar signals which are reflected by the target vehicle. The reflected radar signals are then processed to determine the speed of the target vehicle. These radar devices accurately determine the speed of a target vehicle if the radar device is stationary or if it is in a stationary patrol vehicle. However, if the radar device is in a moving patrol vehicle, the speed of the patrol vehicle must also be taken into account, such as by adjusting or correcting the speed of the target vehicle as determined by the radar device to account for the relative motion of the patrol vehicle.

One of the common problems in moving police radar is the inability for the radar device to always correctly identify the correct ground Doppler return. Typically, the Doppler return when the radar device is in motion will consist of a very complex Doppler waveform. This complex waveform includes the Doppler return waveforms from stationary road side objects as well as the Doppler return waveforms from moving targets moving towards and/or moving away from the radar device. The radar device uses certain methods to overcome these complex waveforms and chooses what it thinks are the best candidate in the Doppler return waveforms. There are numerous conditions that can occur that may cause the radar device to misinterpret and to report an incorrect patrol speed. Common misinterpretations include batching (the radar device is not keeping up with an accelerating patrol vehicle) and shadowing (the radar device chooses a difference frequency between itself and the vehicle in its own lane). These effects are relatively common. Typically, the officer using the radar device has been trained to understand these limitations and other operating anomalies of radar devices. He or she will monitor the patrol speed reading determined by the radar device to determine whether the device is functioning properly. Some prior art radar devices have improved on the patrol speed acquisition problem by analyzing or monitoring certain Doppler waveform traits or signatures, such as in U.S. Pat. No. 5,528,246 to Henderson et al. However, these methods are not perfect and patrol speed misidentification remains a problem. Other radar devices, such as those disclosed in U.S. Pat. No. 5,565,871 to Aker et al. have a patrol reject button to actuate when the radar device is displaying an incorrect patrol speed. The radar device will then search for a different patrol Doppler return elsewhere in the spectrum.

Another method of correctly identifying the patrol speed has been to use the output of the speedometer transducer in the patrol vehicle. The speedometer transducer provides a signal with a frequency proportional to the speed of the vehicle. The radar device receives the speedometer transducer signal, converts it to a speed and then uses the determined speed as a seed to search over a window in the return spectrum for a Doppler waveform with the corresponding patrol speed. A disadvantage of using this method is that the frequency from the speedometer transducer varies with different vehicle manufacturers. As a result, some form of calibration must be performed before using the radar device to take into account the particular frequency of the transducer. This calibration problem is compounded if the radar device is switched to a different vehicle, since re-calibration must then be performed again. In addition to the required calibration, the wire or cable from the speedometer transducer must be located and attached to the radar device. Of course, the location of the speedometer transducer wire or cable varies depending upon the model of the vehicle, and a further step is added to what is likely to be a lengthy manual hookup process.

U.S. Pat. No. 4,335,382 to Brown et al., U.S. Pat. No. 6,023,236 to Shelton and U.S. Pat. No. 6,501,418 to Aker are illustrative of speedometer to radar device interface arrangements. The U.S. Pat. No. 4,335,382 patent teaches using a reference signal from a tachometer device having a frequency proportional to the rotational speed of a vehicle wheel. Complicated electronics including phase locked loops, dividers, frequency to voltage converters, phase detectors and the like are used lock an oscillator to the tachometer signal and to generate the reference signal.

U.S. Pat. No. 6,023,236 to Shelton teaches using the signal from an electronic speedometer as an input to the radar device. The radar device converts the pulses from the speedometer and calculates the speedometer speed.

U.S. Pat. No. 6,501,418 to Aker is concerned with automatically determining whether there is a coupling between a vehicle speed sensor and the radar device. This apparatus determines a ratio between true ground speed and the frequency output of the speed sensor that is then used in subsequent determinations of vehicle speed.

Virtually all vehicles manufactured since 1996 have on-board electronics that can provide information about the speed of the vehicle. Unfortunately, such on-board electronics are designed to, and communicate, on different standards. For example, most foreign vehicles and those of the Daimler-Chrysler Corporation have on-board electronics that are designed in accordance with the ISO 9141 signaling protocol. On the other hand, vehicles manufactured by the General Motors Corporation have on-board electronics that communicate in accordance with a variable pulse-width (VPW) technique, and vehicles manufactured by the Ford Motor Company communicate in accordance with a pulse-width modulation (PWM) technique. These different signaling techniques are generally incompatible with each other because of the utilization of different bus arrangements, baud rates, and the like.

In recent years, cameras and video systems are installed in police vehicles with increasing frequency. These video surveillance systems may be either of the analog type which uses a video tape, or of the digital type which stores the images in digital form in a digital storage medium. These video systems may be of assistance for evidentiary purposes in surveillance situations. Video images of an arrest may also help refute charges, such as police brutality, unreasonable searches and other issues. Such video images may also provide evidence in support of any charges that may be brought, the identity of the vehicle and so forth. Typically, it is desired to have a camera with a wide angle or field of view to capture as much information as possible. However, when a patrol vehicle is in motion, the peripheral information is frequently blurred by the speed of the vehicle and is generally unusable.

There is therefore a need for apparatus that is capable of universally interfacing with the signaling protocols of on-board electronics in all types of vehicles to provide reliable and accurate patrol vehicle speed information to the radar device.

Another need exists to provide an interface between the on-board electronics of the patrol vehicle that will eliminate the need to calibrate the on-board electronics to the radar device.

Yet another need exists to provide an interface between the on-board electronics and the radar device that will permit the radar device to be relocated to a different patrol vehicle without requiring recalibration.

A further need exists that provides for easy and quick installation of such an interface with the existing on-board electronics of the patrol vehicle.

There is also a need for related methods of interfacing with the signaling protocols of all types of vehicles to provide reliable and accurate patrol speed information to the radar device.

A need further exists for such apparatus that can automatically determine which on-board electronic signaling protocol of any vehicle and that can configure itself for operation with the signaling protocol of the vehicle.

Another need exists for apparatus that adjusts the lens of a surveillance camera of a video surveillance system in accordance with the speed of the patrol vehicle to reduce extraneous peripheral information in the field of view at higher speeds.

It is therefore a general object of the present invention to provide apparatus, such as a module, that is capable of universally interfacing with the signaling protocols of the electronics in all types of vehicles to provide reliable and accurate patrol vehicle speed information to the radar device.

It is another object of the present invention to provide related methods of interfacing with the signaling protocols of the on-board electronics in all types of vehicles to provide reliable and accurate patrol speed information to the radar device.

A further object of the present invention is to provide apparatus that can automatically determine which on-board electronic signaling protocol is present and that can configure itself for operation with the identified signaling protocol.

Yet another object of the present invention is to provide apparatus that adjusts the lens of a surveillance camera of a video surveillance system in accordance with the speed of the patrol vehicle to reduce extraneous peripheral information in the field of view at higher vehicle speeds.

A still further object of the present invention is to display and/or record the speed information that is determined by the apparatus with the images taken by the video surveillance system.

### SUMMARY OF THE INVENTION

The present invention is directed to apparatus for interfacing with the On-Board Diagnostic (OBD) computer (also referred to herein as the on-board electronics) in a vehicle with a radar device and/or a video surveillance system. A plurality of data busses are provided for communicating between the on-board electronics and the radar device and/or video surveillance system. These data busses are typically configured for different signaling protocols, such as variable pulse width (VPW), pulse width modulation (PWM) and ISO 9141 that are used by the various forms of the on-board electronics. One or more data processors determine the mode of signaling of the on-board electronics, such as by sequentially activating each of the plurality of data busses, and then select the data bus that is compatible with the on-board electronics. The data processor then communicates with the on-board electronics to receive data, which may be vehicle speed information, or the like, and then translate the received data into a form compatible with the radar device and/or the video surveillance system. The radar device will use the vehicle speed information when a patrol vehicle is in motion to calculate the speed of a target vehicle in a known manner.

The camera may be a video camera for taking images, and it may part of a video surveillance system that also stores the images, either in analog or digital form. A second camera interface module may have a second data processor for receiving the translated data from the data processor and for communicating the translated data in a form for displaying the translated data with the images taken by the camera. Preferably, the camera has an adjustable field of view that can be adjusted in a plurality of steps from a wide angle of view to a narrow angle field of view depending upon the speed of the vehicle or a range of speeds of the vehicle. For example, the camera may be adjusted to a wide angle of view for a stationary vehicle and for slow speeds and may be adjusted to a narrower field of view for intermediate speeds and to a still narrower field of view for higher vehicle speeds. A narrower field of view at higher speeds eliminates peripheral information which is likely to be blurred by the speed of the vehicle.

The present invention also includes methods of interfacing between the on-board electronics in a vehicle and a radar device and/or a video surveillance system where the interface apparatus has a plurality of busses configured to operate with different signaling protocols. One of the methods includes the steps of activating at least one of the plurality of data busses to determine the signaling protocol of the on-board electronics, selecting the data bus from the plurality of data busses that is compatible with the signaling protocol of the on-board electronics, translating the received data into a form compatible with the radar device and/or the video surveillance system, and communicating the translated data to the radar device and/or the video surveillance system. The step of selecting a data bus may include the steps of selecting a variable pulse width bus, a pulse width modulation bus or an ISO 9141 bus. The step of communicating translated data may include the step of communicating speed information.

The methods employed with the video surveillance system may further include displaying the translated data with an image taken by the camera, such as by known metadata techniques. Another step may be to use the translated data to control the field of view of the camera, and to narrow the field of view of the camera at higher vehicle speeds. Controlling the field of view of the camera may be done in a plurality of steps, with each field of view step associated with a range of vehicle speeds.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures in which like reference numerals identify like elements, and in which:

FIG. 1 is a block diagram of the radar and video interface module of the present invention illustrating the interfacing of the module between a radar device and a video surveillance system and the on-board electronics in a vehicle;

FIG. 2 is a block diagram of the of the interface module of FIG. 1 in greater detail;

FIG. 3 is a block diagram of another module for interfacing between the interface module of FIGS. 1 and 2 and a surveillance camera;

FIG. 4 is a schematic diagram of the interface module shown in FIGS. 1 and 2;

FIGS. 5A-5D are flowcharts of software used by the interface module of FIGS. 1 and 2 to determine the mode of operation of the module to coordinate communication in the proper protocol with the on-board electronics installed in a vehicle;

FIG. 6 is a flowchart of the software used by the interface module of FIGS. 1 and 2 for the serial port interrupt of an internal microcontroller;

FIG. 7 is a flowchart of the software used to determine whether the radar device of FIG. 1 operates in the automatic interfacing mode or in the manual patrol mode;

FIGS. 8A and 8B are flowcharts of software used by the radar device of FIG. 1 when in the automatic interfacing mode;

FIG. 9 is a flowchart of software used by the radar device of FIG. 1 to determine whether the radar device is in the automatic interfacing mode or in the manual mode; and

FIG. 10 is a flowchart of software used to adjust the field of view of a camera in the video surveillance system of FIG. 1 in accordance with the speed of the patrol vehicle.

### DESCRIPTION OF THE PREFERRED EMBODIMENT

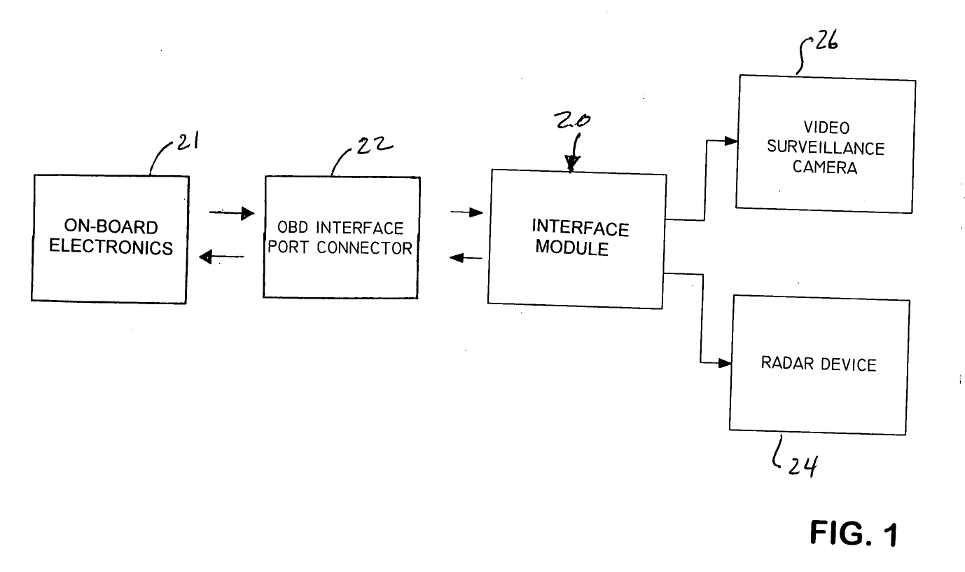

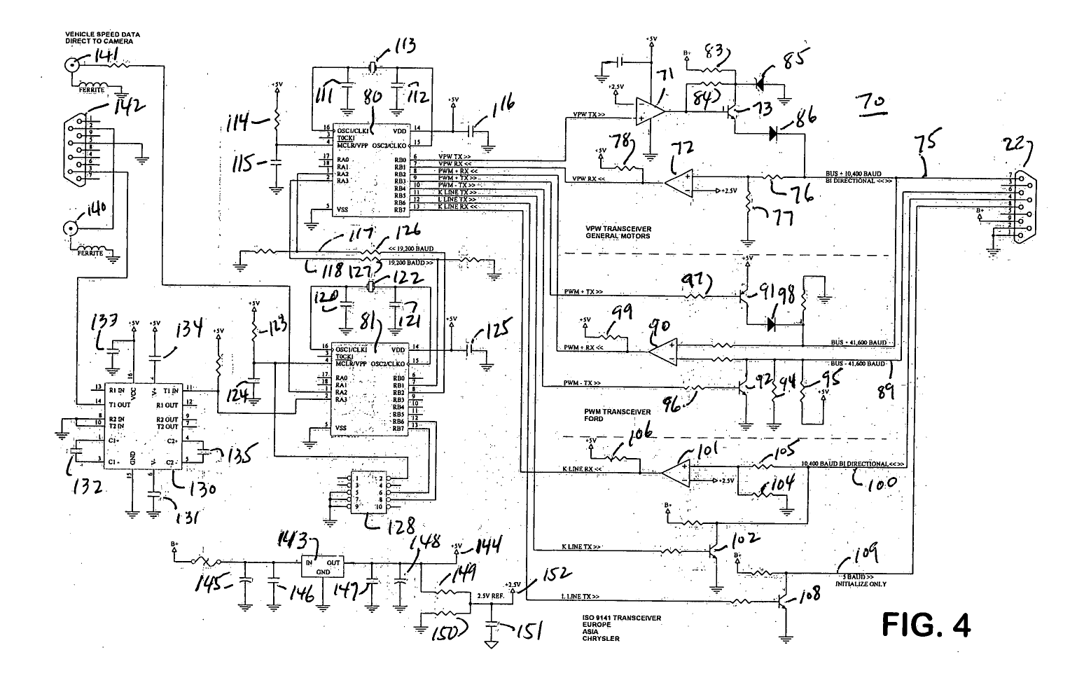

Referring to the Figures, and particularly to FIG. 1, a radar and video interfacing module, generally designated 20, interfaces between an On-Board Diagnostic (OBD) computer or electronics 21 in a motor vehicle and a radar device 24 and/or a video surveillance system 26 via an OBD interface connector 22, and provides communication between the OBD electronics 21 and the radar device 24 and/or the video surveillance system 26. Such OBD computers have been installed in all vehicles since 1996. The radar device 24 thus receives vehicle speed information from the OBD electronics 21 independent of the make or model of the vehicle. The communication path between the OBD electronics 21 and the radar device 24 is provided by electronic circuitry 70, which is described in detail below with reference to FIG. 4. This circuitry interrogates a plurality of different busses to select and use a bus that is compatible with signaling format the OBD electronics. The radar device 24 then automatically receives correct vehicle speed data from the OBD electronics 21. A significant advantage of the present invention is that there is no need to calibrate the radar device to the OBD interface for the particular signaling format of the OBD electronics since module 20 automatically identifies and provides a compatible signaling interface and correctly determines the vehicle speed from any OBD electronics signaling format. Another important advantage of the present invention is that the radar device 24 and module 20 may be relocated to any other vehicle without requiring recalibration since module 20 will quickly and automatically adapt to any new signaling format. A further advantage of the present invention is that module 20 is provided with a standard OBD electronics connector 22 that will plug into the OBD electronics 21. There is therefore no need to search for, and connect to, a speedometer transducer wire or connector.

Of course, module 20 may be in the form of other types of housings, circuit boards or the like. For example, module 20 could be a unitary part of the radar device 24. That is, the electronic functions of module 20 could be designed and integrated into radar device 24, thereby eliminating the need for a separate module. Module 20 provides communication between the OBD electronics 21 and the radar device 24 and/or the camera 26. For example, module 20 may provide the speed of a patrol vehicle to the radar device 24 so that the radar device can accurately take into account the speed of the patrol vehicle in determining the speed of a target vehicle. Similarly, the surveillance camera in the video surveillance system can have its field of view adjusted depending upon the speed of the patrol vehicle, such as by using a wider field of view for slower patrol vehicle speeds and using a narrower field of view for faster patrol vehicle speeds.

While OBD electronics have been installed in all vehicles made since 1996, different versions of the OBD electronics exist. General Motors Corporation has its proprietary OBD design for its vehicles. Ford Motor Corporation similarly has its proprietary design. Daimler-Chrysler Corporation and most of the other vehicle manufacturers design their OBD electronics to an ISO 9141 industry standard. Thus, module 20 preferably accommodates all three OBD electronic designs for adaptability to all vehicles.

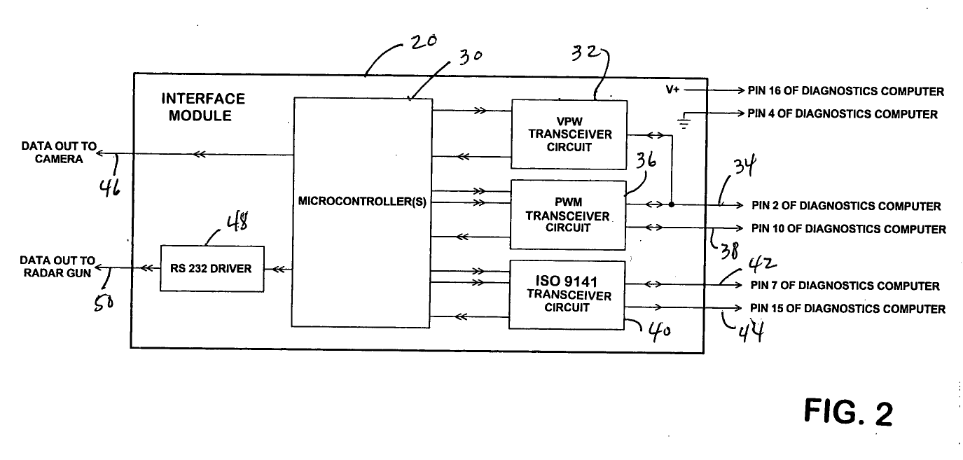

FIG. 2 illustrates the radar and video interfacing module 20 in greater detail. One or more microcontrollers 30 control and coordinate communication between the OBD electronics 21 and the radar device 24 and/or the camera 26. The microcontrollers may be any type of suitable data processors, including microprocessors or the like. In this respect, a variable pulse-width (VPW) transceiver circuit 32 bi-directionally communicates with the microcontrollers 30 and with the OBD electronics 21 via a line 32 for the General Motors signaling protocol. A pulse-width modulation (PWM) transceiver circuit 36 similarly communicates with microcontrollers 30 and with the OBD electronics via lines 34 and 38 for the Ford signaling protocol. Another PWM transceiver 40 communicates with microcontrollers 30 and with the OBD electronics via lines 42 and 44 for the ISO 9141 signaling protocol. Interface module 20 may also or optionally be designed to provide signaling compatibility with the CAN 2.0B bus standard referenced in the SAE J-2264 and ISO-118980 standards. Microcontrollers 30 will determine which of the transceivers 32, 36 or 40 is appropriate for the particular signaling format, i.e., which signaling protocol is applicable in each installation.

Microcontrollers 30 will, in turn, provide information to camera 26 via one or more lines 46. An RS232 driver 48 may receive information from microcontrollers 30, and in turn, provide such information to a radar device 24, such as a hand-held radar gun.

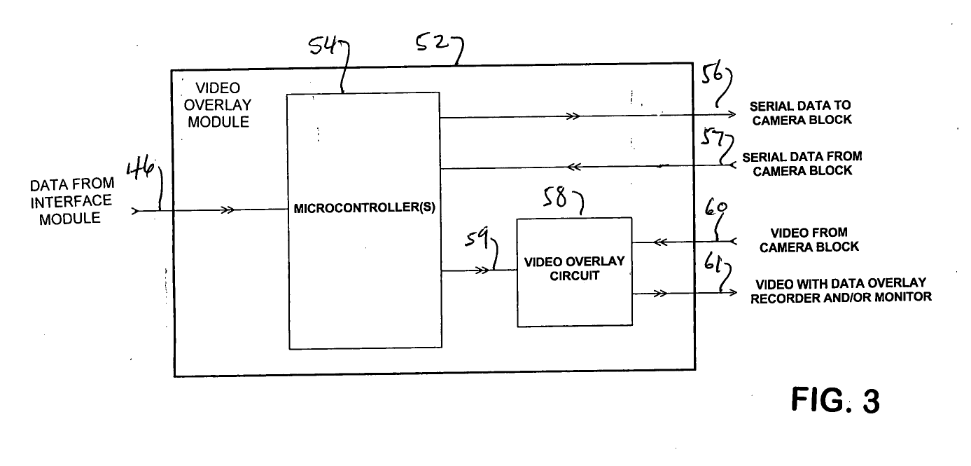

A video module 52 provides further interfacing with camera 26 and is shown in FIG. 3. As with module 20, module 52 may in the form of other types of housings, circuit boards or the like. Of course, it may also be desirable to provide modules 20 and 54 as a unitary module instead of separate modules. In general, video module 52 may display additional data with the images that the camera is taking, such as the time of day, the date, the speed of the patrol vehicle, the identification of the patrol vehicle, and the like. Data from module 20 in FIGS. 1 and 2 is received from one or more microcontrollers 30 on line 46 to one or more microcontrollers 54. Line 56 from the microcontrollers 54 provides serial data to the camera and line 57 receives serial data from the camera. A line 59 from the microcontrollers provides data to a video circuit 58. A line 61 provides video with data from video circuit 58 to the camera, and line 60 receives video from the camera to the video circuit.

The schematic diagram for the electronic circuitry, generally designated 70, for the interface module 20 is shown in FIG. 4. Connector 22 may be of an industry standard type, such as J-1962, to interface with the OBD-II electronics in the motor vehicle, and it consists of 9 pins in this example. Pins 1 and 2 of connector 22 are grounded, pin 9 supplies operating power and pins 4, 6, 7 and 8 are connected to the various busses that comprise the OBD-II interface. The OBD-II interface has provisions for interfacing and communicating with the three different signaling protocols of the automotive manufacturers, as explained above.

The transceiver portion of the circuitry 70 for interfacing with the General Motors (GM) design and specification is shown in the upper right portion of the schematic diagram of FIG. 4. A pair of comparators 71-72 and a transistor 73 are the active elements of a variable pulse width (VPW) transceiver that communicates over a bi-directional bus 75 to pin 7 of connector 22, and hence, to the GM OBD-II electronics. Data is transmitted and received bi-directionally on bus 75 at about 10,400 baud. Comparators 71-72 are commercially available from a number of vendors; for example, from National Semiconductor of Santa Clara, Calif. under part number LM339N. Resistors 76 and 77 form a voltage scaling divider for the input of comparator 72; which has its inverting input terminal referenced to a voltage reference of about +2.5 volts. Resistor 78 is used as a pull up for the output of the receiver comparator 72, with the output of receiver comparator 72 routed to the VPW RX pin 7 of a microprocessor 80.

Comparator 71, resistors 83 and 84 and transistor 73 form the transmitter of the GM transceiver section. Comparator 71 receives information from VPW TX pin 6 of microprocessor 80 at its non-inverting terminal. Its inverting terminal is referenced to a voltage reference of about +2.5 volts. A diode 86 provides protection from the bi-directional bus 75. A Zener diode 85 acts as a voltage reference of approximately 9.1 volts for the collector of transistor 73.

The transceiver portion of the circuitry 70 for interfacing with the Ford Motor Corporation (Ford) design and specification is shown in the middle right portion of the schematic diagram of FIG. 4. Comparator 90 and a pair of transistors 91-92 are the active elements of a pulse width modulated (PWM) transceiver that communicates over positive and negative bi-directional busses 75 and 89, respectively, to pins 7 and 6 of connector 22, and hence, to the Ford OBD-II electronics. Data is transmitted and received bi-directionally on busses 75 and 89 at about 41,600 baud. A pair of resistors 94 and 95 form a voltage scaling network for the inverting input of comparator 90 and generate the proper output voltage levels for the bus signal BUS-41600 on bus 89. A resistor 99 operates as a pull up for the output of comparator 90 and for the PWM RX pin 8 of microprocessor 80. The output terminal of comparator 90 communicates the received data on busses 75 and 89 to the PMW RX pin 8 of microprocessor 80.

A negative PWM transmitter includes resistor 96 and transistor 92. The base terminal of transistor 92 receives data from the PWM−TX pin 10 of microprocessor 80 to transmit data on the negative bus 89. A positive PWM transmitter includes resistor 97 and transistor 91, which receive data from the PWM+TX pin 9 of microprocessor 80. A diode 98 protects transistor 91 from over-voltage conditions that may occur on the bus 75.

The transceiver portion of the circuitry 70 for interfacing with designs that are in accordance with the ISO 9141 specification, including with the Daimler-Chrysler Corporation and many foreign vehicle manufacturers, is shown in the lower right portion of the schematic diagram of FIG. 4. A comparator 101 and a transistor 102 are the active elements of the ISO 9141 transceiver that communicates over a bi-directional bus 100 at about 10,400 baud. Comparator 101 receives data and commands from the bus 100 at its non-inverting terminal. A pair of resistors 104 and 105 form a voltage scaling network for the input of the comparator 101. A resistor 106 is a pull-up for the output of comparator 101 and the K LINE RX pin 13 of microprocessor 80. Comparator 101 thus communicates received data on bus 100 to microprocessor 80. Transistor 102 has its base terminal referenced to the K LINE TX pin 11 of microprocessor 80 and its collector terminal tied to bus 100. Transistor 102 communicates data to be transmitted from microprocessor 80 onto bus 100 to pin 4 of connector 22. Another transistor 108 has its base terminal referenced to the L LINE TX pin 12 of microprocessor 80 and has its collector terminal tied to the 5 BAUD bus 109. Transistor 108 communicates data from microprocessor 80 onto the 5 BAUD bus 109 to pin 8 of connector 22. Transistors 102 and 108 comprise output transistor drivers for communicating to the 10400 BAUD bi-directional bus 100 and to the 5 BAUD bus 109, respectively.

Microcontroller 80 is the main controller for the module 20. Any of a variety of microcontrollers or microprocessors may be suitable for this application. For example, microcontroller 80 may be an 8-bit microcontroller that is commercially available from the Microchip Corporation of Chandler, Ariz. under part number PIC17F84. Microcontroller 80 can communicate with any of the three standard buses of the OBD-II interface. As discussed above, pins 6 and 7 communicate with the GM interface, pins 8-10 communicate with the Ford interface and finally pins 11-13 communicate with the ISO 9141 interface. A pair of capacitors 111 and 112 and a crystal 113 form an oscillator circuit for microcontroller 80 that may oscillate at, for example, at about 20 MHz. A resistor 114 and a capacitor 115 provide a reset signal during initial power on. A capacitor 116 provides power supply de-coupling.

A second microcontroller 81 functions as an interface controller for module 20. While microcontroller 81 could be selected from a variety of commercially available microcontrollers and microprocessors, it may be an 8-bit microcontroller commercially available under part number PIC16F628 from Microchip Corporation. Microcontroller 80 communicates serial speed information to and from microcontroller 81 on a pair of lines 117 and 118. Microcontroller 81 translates the 19200 BAUD rate from microcontroller 80, as on lines 117 and 118 to the lower 1200 BAUD rate required by the external radar device and camera, 24 and 26, respectively. Resistors 126 and 127 in lines 117 and 118, respectively, provide buffering between microcontrollers 80 and 81. A pair of capacitors 120 and 121 and a crystal 122 form a oscillator circuit for microcontroller 122, which may also oscillate at about 20 MHz. A resistor 123 and a capacitor 124 provide a reset signal on initial power on. A capacitor 125 provides power supply de-coupling.

A programming port 128 allows in-circuit re-programmability of microcontrollers 80 and 81. An RS232 interface IC 130 provides RS232 interfacing between the radar device 24, which is connected to a port 140, and microcontroller 81. For example, the RS232 IC 130 is commercially available from Maxim Corporation of Sunnyvale, Calif. under part number MAX232. RS232 IC 130 receives data from microcontroller 81 at T1 IN pin 11. Capacitors 131-135 are used by the RS232 IC 130 to provide positive and negative voltages required for the RS232 interface. IC 130 also supplies data to the camera 26 at a port 141.

Regulated power is supplied to the electronic circuitry 70 by an IC 143, such as that commercially available from the National Semiconductor Company of Santa Clara, Calif. under part number LM349S-5.0. A regulated +5 volts is provided at terminal 144. A plurality of capacitors 145-148 provides power supply decoupling. A pair of resistors 149 and 150 and a capacitor 151 provide a 2.5 volt reference for the inverting terminals of comparators 71, 72 and 101.

The interfacing of the electronic circuitry 70 is as follows. Connector 141 communicates 1200 BAUD rate TTL voltage levels from microcontroller 81 to the external camera 26. Connector 140 is a pass through connector that allows a radar device 24 to transmit speed information to a video recorder unit (not shown). Connector 142 is preferably of the DB-9 type to interfaces with the radar device 24. The radar device 24 receives data from the RS232 IC 130 at pin 3 of connector 142. Data transmitted from the radar device 24 is routed from pin 2 of connector 142 to the pass through connector 140.

It will be appreciated by those skilled in the art that various alternatives, variations and changes may be made to the electronic circuitry 70. Instead of designing the circuitry 70 with discrete components, other parts are also commercially available for designing and implementing OBD-II interfaces. For example, Motorola Inc. of Schaumburg, Ill. manufactures several OBD-II interface chips, such as the MC33290 serial link bus interface, which communicates directly between a microcontroller and the ISO 9141 bus.

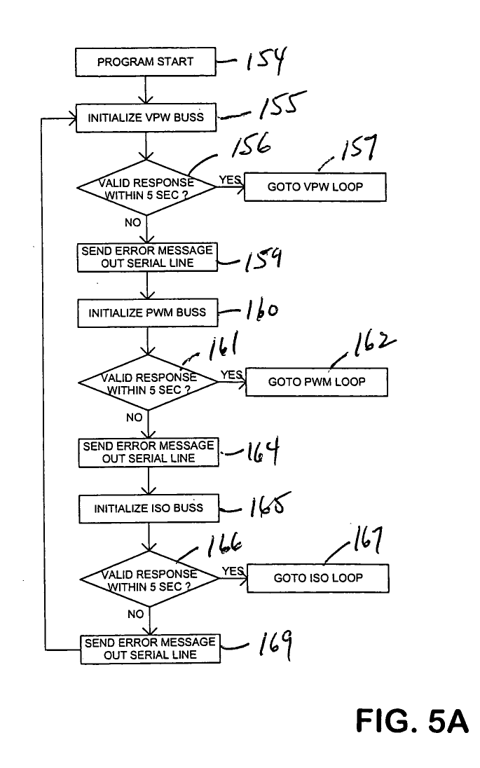

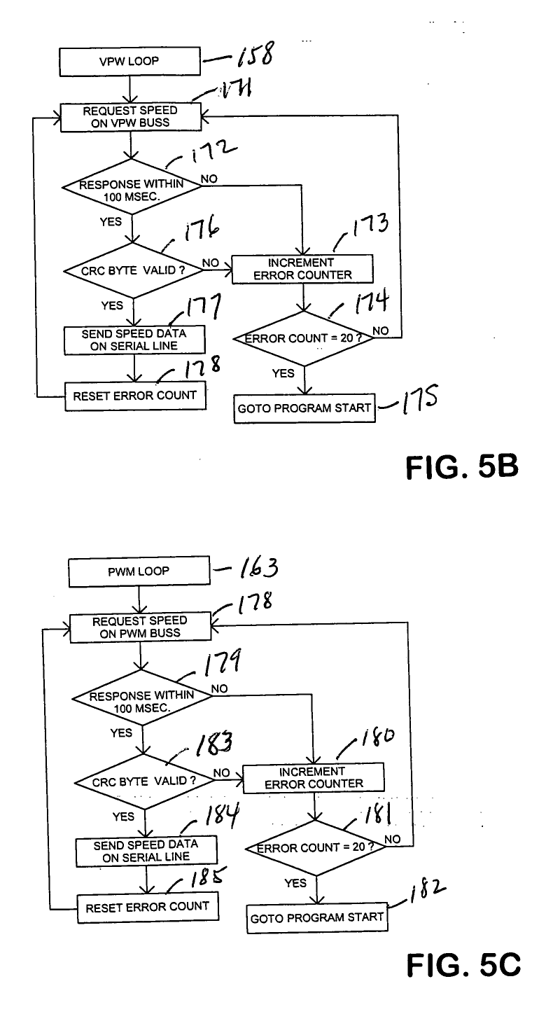

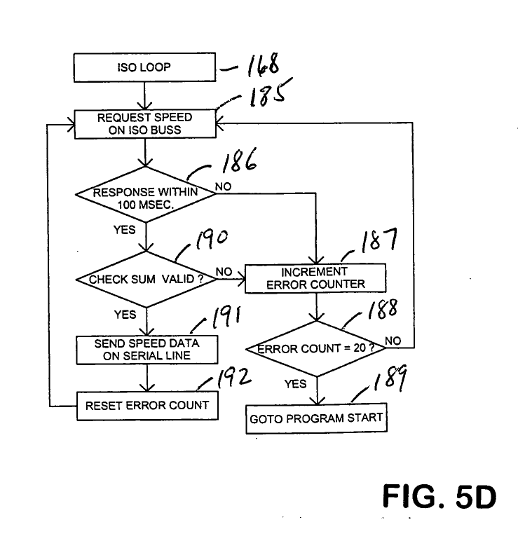

The module 20 determines the mode of operation of the on-board electronics by sequentially activating the various busses to establish communication with the on-board electronics in the appropriate signaling protocol, as seen in the software flowcharts of FIGS. 5A-5D. The main program starts at block 155 of FIG. 5A by instructing microcontroller 80 to initialize the VPW bus 75. The routine waits for 5 seconds at decision block 156 for a valid response. If a response is received, the routine branches over to the VPW loop at block 157 and to the VPW loop of block 158 in FIG. 5B. If no response is received, the routine sends out a error string at block 159 and branches down to test the PWM bus 75 and 89. The PWM bus is initialized at block 160 and the routine waits 5 seconds at block 161 for a response. If a response is received, the routine branches over to the PWM loop of block 162 and to the PWM loop routine beginning at block 163 of FIG. 5C. If no response is received, the routine sends out an error string at block 164 and branches down to test the ISO bus. The ISO bus 100 and 109 is initialized at block 165 and the routine waits 5 seconds for a response at block 166. If a response is received, the routine branches over to the ISO loop at block 167 and to the ISO routine at block 168 in FIG. 5C. If no response is received, the routine sends out an error string at block 169 and branches back to the program start.

The VPW routine begins at block 158 of FIG. 5B. The routine requests speed data from VPW bus 75 at block 171. If no response is received within 100 milliseconds at block 172, the routine increments an error count at block 173. If the error count reaches 20 at block 174, the routine will go to the program start at block 175, which causes a return to the program start block 154 in FIG. 5A. If the error count is less than 20, the routine will again request speed data from the VPW bus at block 171. If a speed is received at block 172, its CRC byte is checked for validity at block 176. If the speed is valid, it is sent out on the serial port at block 177, the error count is reset at block 178 and the routine jumps back to request a additional speed from the bus at block 171. If the speed of the CRC value is incorrect, the error count is incremented at block 173 and checked at block 174 before jumping back to request a new speed at block 171.

The PMW routine begins at block 163 of FIG. 5C. The routine requests speed data from PMW bus at block 178. If no response is received within 100 milliseconds at block 179, the routine increments an error count at block 180. If the error count reaches 20 at block 181, the routine will go to the program start at block 182 and back to program start block 154 of FIG. 5A. If the error count is less than 20, the routine will again request speed data from the PMW bus at block 179. If a speed is received at block 179, its CRC byte is checked for validity at block 183. If the speed is valid, it is sent out on the serial port at block 184, the error count is reset at block 185 and the routine jumps back to request a additional speed from the bus at block 178. If the speed associated with the CRC value is incorrect at block 183, the error count is incremented at block 180 and checked at block 181 before jumping back to request a new speed at block 178.

The ISO routine begins at block 168 of FIG. 5D. The routine requests speed data from ISO bus at block 185. If no response is received within 100 milliseconds at block 186, the routine increments a error count at block 187. If the error count reaches 20 at block 188, the routine will go to the program start at block 189, and then back to program start block 154 in FIG. 5A. If the error count is less than 20 at block 188, the routine will again request speed data from the ISO bus at block 186. If a speed is received at block 186, its CRC byte is checked for validity at block 190. If the speed is valid, it is sent out on the serial port at block 191, the error count is reset at block 192 and the routine jumps back to request a additional speed from the bus at block 185. If the speed associated with CRC value is incorrect at block 190, the error count is incremented at block 187 and checked at block 188 before jumping back to request a new speed at block 185.

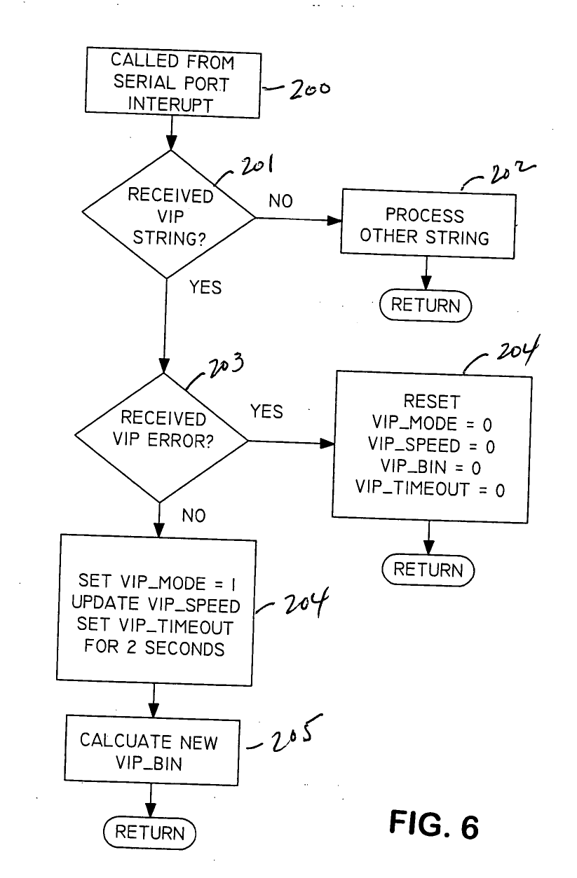

FIG. 6 is a flowchart of the programming steps for the serial port interrupt beginning at block 200. When the radar device 24 receives a serial 8-bit word from the interface module, the execution of software in the radar device jumps to this block. The string received (composed of three words) is checked to verify it came from the interface module at block 201. The radar device will process the received string differently, as at block 202, if it is not from the interface module. If an automatic interface string was received, it is checked for an error code at block 203. An error code will force the VIP (automatic interface mode) variables VIP_MODE, VIP_SPEED, VIP_BIN and VIP_TIMEOUT to be set to zero for operation of the interface module in the manual mode at block 204. If the VIP string was received correctly, the following variables are set for the automatic mode of operation: VIP_MODE=1, VIP_SPEED is updated with the value located in the string and VIP_TIMEOUT is set to a value representing a two second timeout at block 204. VIP_TIMEOUT is used to detect if the interface module was removed or an interface error became present. Finally at block 205, VIP_BIN is calculated by converting VIP_SPEED into an equivalent fast Fourier transform (FFT) bin number. VIP_BIN is used in the automatic patrol interfacing routine to determine a valid patrol FFT bin. The serial string received from the interface module contains a three word 8 bit string consisting of an ASCII O, the binary speed in KPH and a carriage return <CR> or decimal 13. If an error is received, the string will be ASCII E, binary speed of zero, and a <CR>. Baud rates are 1200, 8 data bits and no parity. It will be appreciated that many different serial formats could be used.

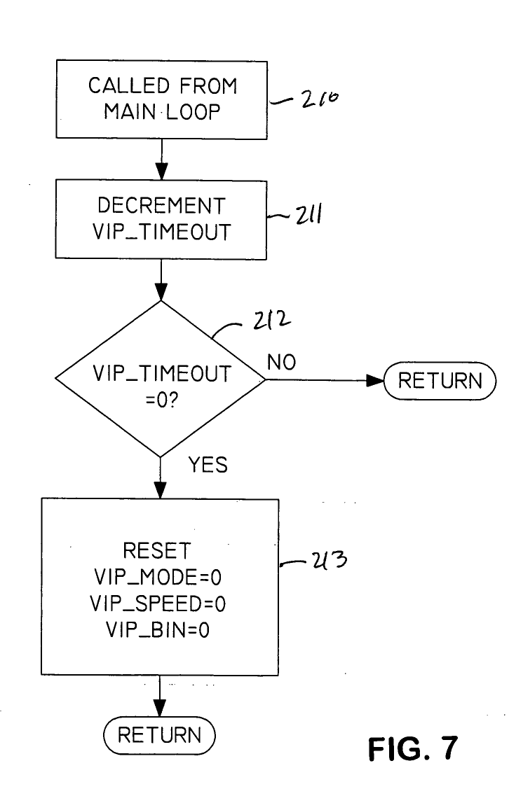

FIG. 7 is a flowchart of the VIP_TIMEOUT process. This routine is called from the main program at block 210 and is used to decrement the VIP_TIMEOUT variable at block 211. If the VIP_TIMEOUT variable has expired, the VIP variables are reset at block 213 and the radar device defaults to the manual patrol interfacing mode. VIP_MODE, VIP_SPEED and VIP_BIN will all be set to zero.

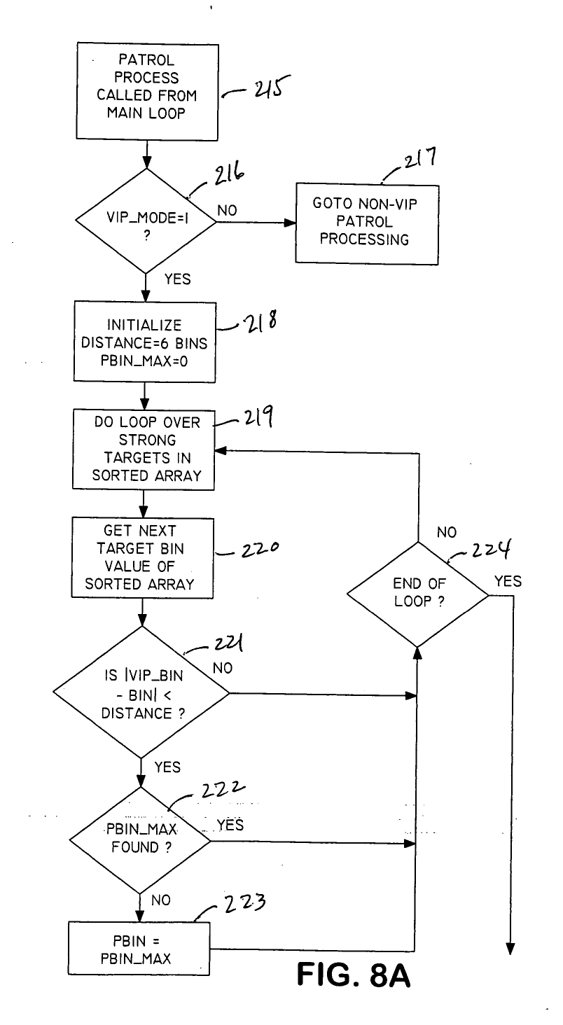

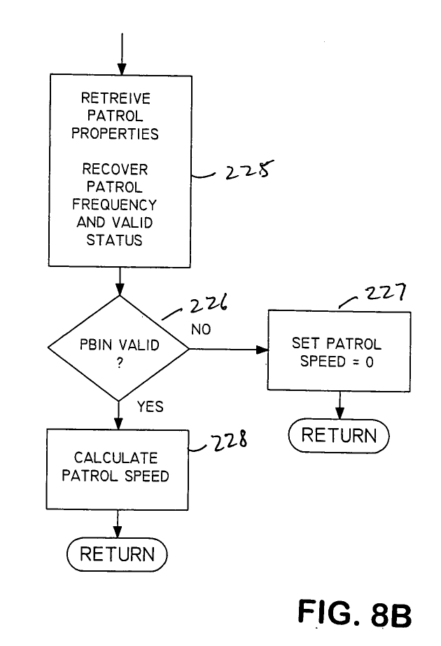

FIGS. 8A and 8B are flowcharts for the automatic patrol interfacing routine. The routine is called from the main program at block 215. First, it is determined if the radar is in VIP_MODE at block 216. If VIP_MODE is set to zero, the processing jumps to manual patrol processing at block 217. In the manual processing mode, the radar device processes the patrol speed Doppler return in a conventional manner. The VIP_MODE was set in FIG. 6 if a valid VIP string was received. If VIP_MODE is set to a one, the radar device will drop down into patrol automatic interfacing mode. The routine next initializes the distance in bins from which to process the VIP_BIN value. In this example, 6 bins are used to define the maximum distance from the VIP_BIN value at block 218. PBIN_MAX is initialized to zero and is used as a flag to determine if a patrol speed was found in the search. A loop is next executed at block 219 to search for the closest target to the VIP_BIN value. The loop is executed over an array of sorted top strong targets at block 220, searching from the strongest target in the return (bin value=0) to the Nth strong target (bin_value-1). The array of targets is calculated in an earlier step main program function by finding the strongest target in the return and placing its reference value in bin location 0, the second strongest target in the return in bin location 1, the third strongest in bin location 2 and so on. N equals 25 in this case but may vary and is not a limitation. The routine picks out the next bin value from the sorted array at block 220 and compares its distance to VIP_BIN value. If the magnitude of the distance at block 221 is less than the required amount defined earlier by DISTANCE then this FFT bin value is used as the patrol bin. If the patrol bin is found, PBIN_MAX is initialized to the FFT bin location. The loop continues to execute while checking on PBIN_MAX at block 222 to determine if it has been updated. If PBIN_MAX equals a non-zero value it is not updated with any new values at block 223. The loop will exit when the loop variable has decremented to zero at block 224, and goes to block 225 of FIG. 8B. The routine next retrieves the target information located at PBIN_MAX which provides frequency information and valid properties about the patrol signal at block 225. The patrol signal is next checked to determine if it is valid at block 226. The patrol signal will be valid if its frequency has been within a certain threshold over a period of time. If PBIN is not valid, the patrol speed value is set to zero at block 227 and procedure returns. If PBIN is valid it is converted into a speed at block 228 and the procedure returns. The radar will display the valid patrol speed in the patrol window.

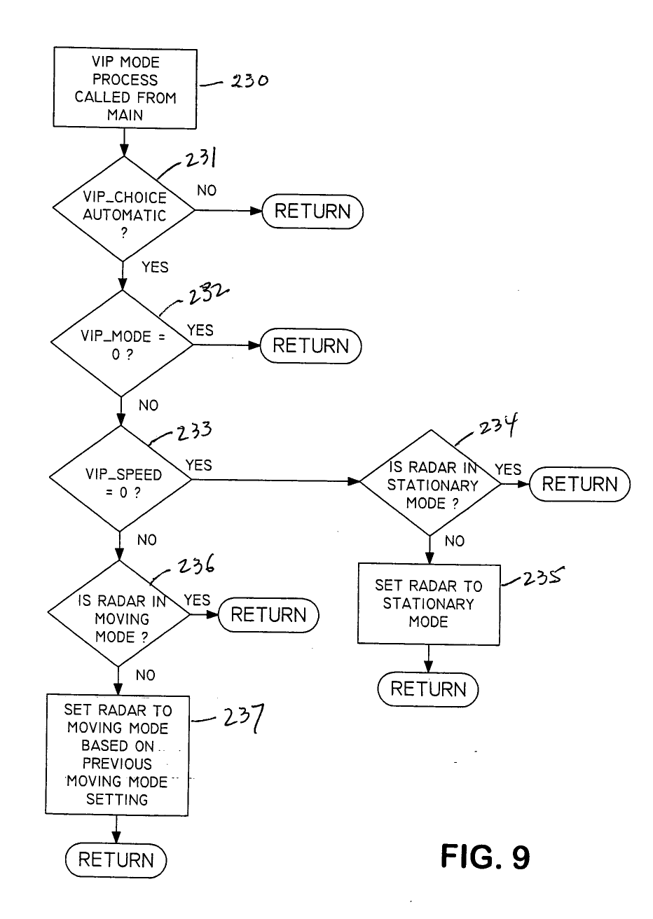

FIG. 9 is a flowchart for the automatic/manual switchover capability of the radar device beginning at block 230. For ease of operation, it is desirable to have the radar device automatically switch over to stationary mode if the patrol vehicle is stopped. Likewise, it is also desirable to have the radar device to switch back to moving mode once the patrol vehicle is moving again. It is also important from the operator's point of view that the mode switchover be selectable from either automatic or manual settings. The radar device preferably contains a software menu that the operator can use to select between manual and automatic mode switchover. VIP_CHOICE at block 231 is the variable used to hold the state of the manual/automatic switchover and its status is saved in non-volatile memory on power down and recalled on power up. First, the VIP_CHOICE variable is checked to determine if the radar is in automatic or manual mode switchover. The routine exits if VIP_CHOICE is equal to a 1 meaning that the radar is in manual mode. In manual switchover mode, the radar will display a zero in the patrol window when the radar device has come to a stop and will not display any target speeds nor will the device switch over automatically to stationary mode.

If VIP_CHOICE is zero (automatic mode), the routine drops down to block 232 and checks for VIP_MODE. If VP_MODE=0 then the routine exits because no VIP module is connected. If VIP_MODE=1, the routine drops down to block 233 and checks the VIP_SPEED value. If VIP_SPEED=0 the routine will check to determine if the radar is in stationary mode at block 234. If VIP_SPEED=0 and the radar is in stationary mode, the radar device is set to the stationary mode at block 235 and the routine exits because the radar device is already in the correct mode. However, if VIP_SPEED is non-zero at block 233, the routine checks if the radar is in moving mode at block 236. If the radar is in moving mode, the routine exits. If VIP_SPEED is non-zero and the radar device is in stationary mode, the routine places the radar device into moving mode at block 237 based upon the previous moving mode of the radar device and exits.

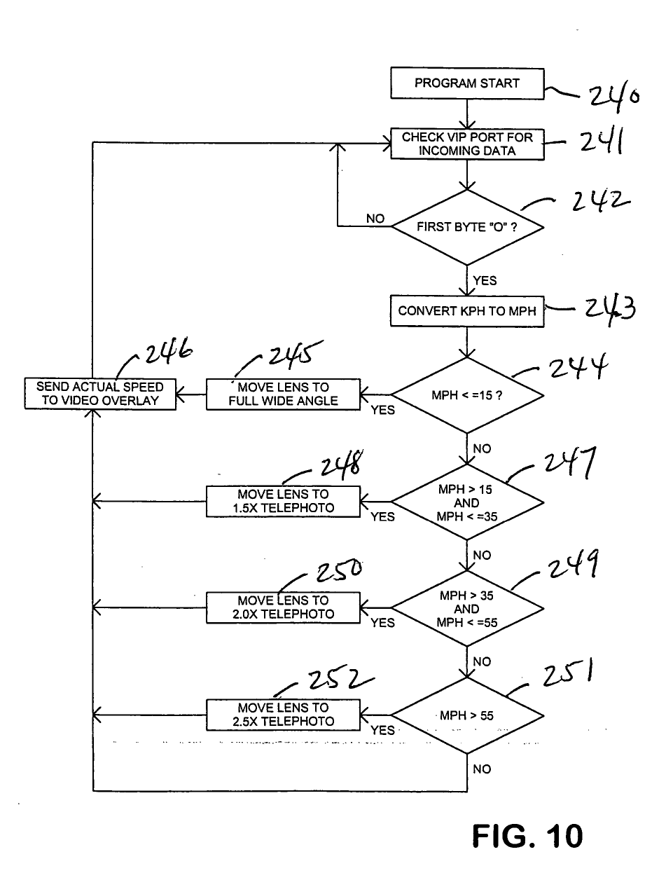

FIG. 10 is a flowchart for providing information to a video surveillance system 26 in FIG. 1, which may include a camera, a digital storage medium, a video recorder, and/or the like. In addition to providing speed information to a radar device, the interface module can also provide information to the camera 26 located in a video surveillance system, and which forms part of a video surveillance system. For example, the video surveillance system 26 may be an analog system that records onto a video tape. For an analog system, all of the information is stored as part of the video signal, including any speed information or information of the like furnished by interface module 20, is stored as part of the video signal on the tape. However, preferably, the video surveillance system is a digital video system that digitizes the video information. Additional information or metadata, which may include time, date, vehicle identification, frame number, vehicle speed and the like, is associated with the digitized data on a frame by frame basis, in a manner known to the art. The playback software then combines the digitized data and the metadata to recreate the images. Since the metadata is in digital form, it may not be desired to display all of the data on playback. The metadata may be used in other ways such as tags for searching. For example, the vehicle speed data from the interface module 20 could be used to adjust the field of view of a camera in the video surveillance system, and the speed information could be displayed on the images created by the camera, either instantaneously or on playback, or not, as desired.

It is frequently desirable to adjust the zoom level of the camera depending on the present speed of the patrol vehicle. It is known that the information in the peripheral view of the camera typically becomes more and more extraneous as the speed of the patrol vehicle increases. For example, as the speed of the patrol vehicle increases, peripheral roadside objects may appear blurred. In addition, target vehicles of the radar device are usually spread further apart at highway speeds. This causes a wider angle image or a wider field of view, which is suitable for slower traffic and/or slower patrol speeds, to have less detail and less sharpness for faster traffic and/or for faster patrol speeds. Thus, it can be appreciated that adjustment of the zoom feature of the camera based upon the speed of the patrol vehicle is desirable. In particular, it is desirable to have a higher zoom factor at higher patrol vehicle velocities.

An exemplary flowchart for adjusting the zoom of the lens of the camera is set forth in FIG. 10. Software located at the camera 26 will receive data from the interface module 20 and use the speed information to control the field of view of the camera. After starting at block 240, the program waits for incoming data from the VIP port at block 241. The routine checks if the first byte received in the string is a “O” at block 242. If not, the routine returns back to checking the VIP port. If a “O” was received, the binary speed is converted to from kilometers per hour (KPH) to miles per hour (MPH) at block 243. The next decision block 244, checks the patrol speed to determine if it is less than about 15 MPH. If the patrol speed is less than 15 MPH, the routine causes adjustment of the camera lens to about full wide angle at block 245. The routine next sends the actual present speed of the patrol vehicle for video display of the speed with the image produced by the camera at block 246.

If the patrol speed is greater than about 15 MPH and less than about 35 MPH at block 247, the routine adjusts the camera lens to about 1.5× at block 248 and, as before, sends the present speed of the patrol vehicle to the camera for display on the camera's image. If the patrol speed is greater than about 35 MPH and less than about 55 MPH at block 249, the routine adjusts the camera lens to about 2.0× at block 250 and sends the present patrol vehicle speed to the camera for display on the camera's image at block 246. If the patrol speed is greater than about 55 MPH at block 251, the routine will adjusts the camera lens to about 2.5× and, as before, the speed is sent to the camera for video display. It will be appreciated that the speed ranges and camera adjustments in the foregoing example are set forth as an example of practicing the present invention and that other speed ranges and camera lens settings may be also be suitable for practicing the present invention.

It will be understood that the embodiments of the present invention that have been described are illustrative of some of the applications of the principles of the present invention. Various changes and modifications may be made by those skilled in the art without departing from the true spirit and scope of the invention.

1. An apparatus for interfacing between on-board electronics in a vehicle and a radar device, said apparatus comprising:
a plurality of data busses for communicating between the apparatus and the on-board electronics, with each bus in said plurality of data busses configured for a different signaling protocol;
a data processor for determining the signaling protocol of the on-board electronics by activating at least one of said plurality of data busses and for selecting a data bus from the plurality of data busses with a signaling protocol that is compatible with the signaling protocol of the on-board electronics;
said data processor communicating with the on-board electronics on the selected data bus to receive data from the on-board electronics; and
said data processor translating the received data into a form compatible with said radar device and communicating the translated data to the radar device.

2. The apparatus for interfacing between on-board electronics in a vehicle and a radar device as claimed in accordance with claim 1 wherein said received data and said translated data are vehicle speed information.

3. The apparatus for interfacing between on-board electronics in a vehicle and a radar device as claimed in accordance with claim 1 further comprising:
a video surveillance system for taking images; and
a second data processor for receiving the translated data from said data processor and for communicating the translated data to said video surveillance system in a form for displaying or recording the translated data with said images.

4. The apparatus for interfacing between on-board electronics in a vehicle and a radar device as claimed in accordance with claim 3 wherein said translated data that is displayed with said images is vehicle speed information.

5. The apparatus for interfacing between on-board electronics in a vehicle and a radar device as claimed in accordance with claim 1 wherein one of said plurality of data busses is configured for signaling in the variable pulse width mode.

6. The apparatus for interfacing between on-board electronics in a vehicle and a radar device as claimed in accordance with claim 1 wherein another of said plurality of data busses is configured for signaling in the pulse width modulated mode.

7. The apparatus for interfacing between on-board electronics in a vehicle and a radar device as claimed in accordance with claim 1 wherein yet another of said plurality of data busses is configured for signaling in the ISO 9141 mode.

8. The apparatus for interfacing between on-board electronics in a vehicle and a radar device as claimed in accordance with claim 1 wherein yet another of said plurality of data busses is configured for signaling in the CAN 2.0B mode.

9. The apparatus for interfacing between on-board electronics in a vehicle and a radar device as claimed in accordance with claim 2 wherein said radar device has a moving mode and a stationary mode, said radar device automatically switching to the stationary mode if the vehicle speed information indicates that the speed of the vehicle is zero and automatically switching to the moving mode if the vehicle speed information is not zero.

10. An apparatus for interfacing between on-board electronics in a vehicle and a video surveillance system for taking images, said apparatus comprising:
a plurality of data busses for communicating between the apparatus and the on-board electronics, with each bus in said plurality of data busses configured for a different signaling protocol;
a data processor for determining the signaling protocol of the on-board electronics by activating at least one of said plurality of data busses and for selecting a data bus from the plurality of data busses with a signaling protocol that is compatible with the signaling protocol of the on-board electronics;
said data processor communicating with the on-board electronics on the selected data bus to receive data from the on-board electronics; and
said data processor translating the received data into a form compatible with said video surveillance system and communicating the translated data to the video surveillance system.

11. The apparatus for interfacing between on-board electronics in a vehicle and a video surveillance system as claimed in accordance with claim 10 further comprising:
a second data processor for receiving the translated data from said data processor and for communicating the translated data to said video surveillance system in a form for displaying or recording of the translated data with said images.

12. The apparatus for interfacing between on-board electronics in a vehicle and a video surveillance system as claimed in accordance with claim 10 wherein said received data and said translated data are vehicle speed information,
a camera of said video surveillance system has a field of view that is variable in response to said translated data whereby the field of view of the camera changes with the speed of the vehicle.

13. The apparatus for interfacing between on-board electronics in a vehicle and a camera as claimed in accordance with claim 12 wherein the field of view of the camera is narrowed in a plurality of steps as the speed of the vehicle increases from zero, with each of said steps associated with a range of speed of the vehicle.

14. A method of interfacing between the on-board electronics in a vehicle and a radar device with an interface apparatus having a data processor and a plurality of busses configured to operate with different signaling protocols, said method comprising the steps of:
activating at least one of the plurality of data busses to determine the signaling protocol of the on-board electronics;
selecting the data bus from the plurality of data busses with a signaling protocol that is compatible with the signaling protocol of the on-board electronics;
receiving data at the data processor over the selected data bus from the on-board electronics;
translating the received data into a form compatible with said radar device; and
communicating the translated data to said radar device.

15. The method of interfacing between the on-board electronics in a vehicle and a radar device as claimed in accordance with claim 14 wherein the step of selecting the data bus from a plurality of data busses includes the step of selecting a bus with a variable pulse width signaling protocol.

16. The method of interfacing between the on-board electronics in a vehicle and a radar device as claimed in accordance with claim 14 wherein the step of selecting the data bus from a plurality of data busses includes the step of selecting a bus with a pulse width modulation signaling protocol.

17. The method of interfacing between the on-board electronics in a vehicle and a radar device as claimed in accordance with claim 14 wherein the step of selecting the data bus from a plurality of data busses includes the step of selecting a bus with an ISO 9141 signaling protocol.

18. The method of interfacing between the on-board electronics in a vehicle and a radar device as claimed in accordance with claim 14 wherein the step of selecting the data bus from a plurality of data busses includes the step of selecting a bus with a CAN 2.0B signaling protocol.

19. A method of interfacing between the on-board electronics in a vehicle and a video surveillance system for taking images with an interface apparatus having a data processor and a plurality of data busses configured to operate with different signaling protocols, said method comprising the steps of:
activating at least one of the plurality of data busses to determine the signaling protocol of the on-board electronics;
selecting the data bus from the plurality of data busses with a signaling protocol that is compatible with the signaling protocol of the on-board electronics;
receiving data at the data processor over the selected data bus from the on-board electronics;
translating the received data into a form compatible with said video surveillance system;
communicating the translated data to said video surveillance system; and
displaying of the translated data with said images of the video surveillance system.

20. A method of interfacing between the on-board electronics in a vehicle and a video surveillance system for taking images with an interface apparatus having a data processor and a plurality of data busses configured to operate with different signaling protocols, said method comprising the steps of:
activating at least one of the plurality of data busses to determine the signaling protocol of the on-board electronics;
selecting the data bus from the plurality of data busses with a signaling protocol that is compatible with the signaling protocol of the on-board electronics;
receiving data at the data processor over the selected data bus from the on-board electronics;
translating the received data into a form compatible with said video surveillance system;
communicating the translated data to said video surveillance system; and
recording of the translated data and said images of the video surveillance system.

21. An apparatus for interfacing between on-board electronics in a vehicle and a radar device, said apparatus comprising:
a data bus for communicating between the apparatus and the on-board electronics;
a data processor for communicating with the on-board electronics on the data bus to receive data from the on-board electronics; and
said data processor translating the received data into a form compatible with said radar device and communicating the translated data to the radar device.

22. The apparatus for interfacing between on-board electronics in a vehicle and a radar device as claimed in accordance with claim 21 wherein said received data and said translated data are vehicle speed information.

23. The apparatus for interfacing between on-board electronics in a vehicle and a radar device as claimed in accordance with claim 21 further comprising:
a video surveillance system for taking images; and
a second data processor for receiving the translated data from said data processor and for communicating the translated data to said video surveillance system in a form for displaying or recording of the translated data with said images.

24. The apparatus for interfacing between on-board electronics in a vehicle and a radar device as claimed in accordance with claim 21 wherein said translated data that is displayed with said images is vehicle speed information.

25. A method of interfacing between the on-board electronics in a vehicle and a radar device with an interface apparatus having a data processor and a data bus for communicating between said data processor and the on-board electronics, said method comprising the steps of:
receiving data at the data processor over the data bus from the on-board electronics;
translating the received data into a form compatible with said radar device; and
communicating the translated data to said radar device.

26. A method of interfacing between the on-board electronics in a vehicle and a video surveillance system for taking images with an interface apparatus having a data processor and a data bus for communicating between said data processor and the on-board electronics, said method comprising the steps of:
receiving data at the data processor over the data bus from the on-board electronics;
translating the received data into a form compatible with said camera;
communicating the translated data to said video surveillance system; and
displaying of the translated data with said images of the video surveillance system.

27. A method of interfacing between the on-board electronics in a vehicle and a video surveillance system for taking images with an interface apparatus having a data processor and a data bus for communicating between said data processor and the on-board electronics, said method comprising the steps of:
receiving data at the data processor over the data bus from the on-board electronics;
translating the received data into a form compatible with said camera;
communicating the translated data to said video surveillance system; and
recording of the translated data and said images of the video surveillance system.

28. A method of interfacing between the on-board electronics in a vehicle and a video surveillance system for taking images with an interface apparatus having a data processor and a data bus for communicating between said data processor and the on-board electronics, said method comprising the steps of:
receiving data at the data processor over the data bus from the on-board electronics;
translating the received data into a form compatible with said video surveillance system;
communicating the translated data to said video surveillance system; and
using the translated data to control the field of view of a camera of the video surveillance system.

29. The method of interfacing between the on-board electronics in a vehicle and a video surveillance system as claimed in accordance with claim 28 wherein the step of using the translated data to control the field of view of the camera includes the step of:
narrowing the field of view of the camera at higher vehicle speeds.

30. The method of interfacing between the on-board electronics in a vehicle and a video surveillance system as claimed in accordance with claim 28 wherein the step of using the translated data to control the field of view of the camera includes the step of:
narrowing the field of view of the camera in a plurality of steps as the speed of the vehicle increases from zero, with each of said steps associated with a range of speed of the vehicle.

31. The method of interfacing between the on-board electronics in a vehicle and a video surveillance system as claimed in accordance with claim 30 wherein the step of narrowing the field of view of the camera in a plurality of steps includes the step of:
changing the field of view of the camera to an adjacent step when the speed of the vehicle changes to a different range of speed.

32. An apparatus for interfacing with on-board electronics in a patrol vehicle, said apparatus comprising:
a radar device for determining the speed of a target vehicle;
a plurality of data busses for communicating between the apparatus and the on-board electronics, with each bus in said plurality of data busses configured for a different signaling protocol;
a data processor for determining the signaling protocol of the on-board electronics by activating at least one of said plurality of data busses and for selecting a data bus from the plurality of data busses with a signaling protocol that is compatible with the signaling protocol of the on-board electronics;
said data processor communicating with the on-board electronics on the selected data bus to receive data from the on-board electronics;
said data processor translating the received data into a form compatible with said radar device and communicating the translated data to the radar device; and
said radar device using the translated data to determine the speed of the patrol vehicle and using the speed of the patrol vehicle in determining the speed of the target vehicle.

33. The apparatus for interfacing with on-board electronics in a patrol vehicle as claimed in accordance with claim 32 wherein said received data and said translated data are vehicle speed information.

34. The apparatus for interfacing with on-board electronics in a patrol vehicle as claimed in accordance with claim 32 further comprising:
a video surveillance system for taking images; and
a second data processor for receiving the translated data from said data processor and for communicating the translated data to said video surveillance system in a form for displaying or recording the translated data with said images.

35. The apparatus for interfacing with on-board electronics in a patrol vehicle as claimed in accordance with claim 34 wherein said translated data that is displayed with said images is vehicle speed information.

36. The apparatus for interfacing with on-board electronics in a patrol vehicle as claimed in accordance with claim 32 wherein one of said plurality of data busses is configured for signaling in the variable pulse width mode.

37. The apparatus for interfacing with on-board electronics in a patrol vehicle as claimed in accordance with claim 32 wherein another of said plurality of data busses is configured for signaling in the pulse width modulated mode.

38. The apparatus for interfacing with on-board electronics in a patrol vehicle as claimed in accordance with claim 32 wherein yet another of said plurality of data busses is configured for signaling in the ISO 9141 mode.

39. The apparatus for interfacing with on-board electronics in a patrol vehicle as claimed in accordance with claim 32 wherein yet another of said plurality of data busses is configured for signaling in the CAN 2.0B mode.

40. The apparatus for interfacing with on-board electronics in a patrol vehicle as claimed in accordance with claim 33 wherein said radar device has a moving mode and a stationary mode, said radar device automatically switching to the stationary mode if the vehicle speed information indicates that the speed of the vehicle is zero or automatically switching to the moving mode if the vehicle speed information is not zero.
